(19) United States
(12) Patent Application Publication
(10) Pub. No.: US 2008/0185092 A1
(43) Pub. Date: Aug. 7, 2008

(54) Tip printing embossed surfaces

(75) Inventor: Gary P. Blenkhorn, Cape Elizabeth, ME (US)

Correspondence Address: FISH & RICHARDSON PC, P.O. BOX 1022, MINNEAPOLIS, MN, 55440-1022, US

(73) Assignee: S.D. WARREN COMPANY, (--)

(21) Appl. No.: 11/670,627

(22) Filed: Feb. 2, 2007

(51) Int. Cl. B29C 59/04

(52) U.S. Cl. 156/209; 428/42.1

(57) ABSTRACT

Methods are provided for manufacturing sheet-form products which carry an embossed texture and a printed pattern in register with the embossed texture. One method includes (a) providing a sheet-form substrate having a surface; (b) providing an embossing medium carrying an embossed pattern defining raised portions and recessed portions; (c) applying an ink to the raised portions of the embossed pattern; (d) transferring the ink from the embossing medium to the surface of the substrate, and (e) applying pressure to the embossing medium and substrate to impart the inverse of the embossed pattern to the surface of the substrate to form the sheet-form product. Sheet-form products are also provided.

### TECHNICAL FIELD

This invention relates to a process for printing a pattern-in-register with an embossed surface, for example a surface of a laminated product.

### BACKGROUND

Laminates are usually created under heat and pressure. Some laminates are formed by reacting or cross linking a melamine decorative sheet either directly to medium density fiberboard (MDF), high density fiberboard (HDF), or particle board, or by laminating the melamine sheet to one or more phenolic treated cellulosic paper sheet(s). In the latter case, the resulting laminate may be glued or bonded to another material such as plywood, MDF, HDF or particle board. The finished product is often intended to simulate a naturally occurring surface such as wood, stone, slate, etc.

These types of naturally occurring materials usually have a topographical texture that is “in register” with the natural coloration of the material, for example a surface disruption caused by wood ticks in wood, or a vein in marble. It is difficult to incorporate this naturally occurring “embossed in register” effect into artificially created panels or laminate.

One method currently used to simulate this effect is to create a décor (decorative surface layer of the laminate) with a print that, at least partially, registers with a corresponding three-dimensional pattern on an embossing medium such as an embossed release paper or an embossed caul plate. The embossing medium is either permanently mounted in the press, such as an embossed caul plate would be, or is fed into the press, as an embossed release paper would be. In either case, the décor is introduced into the press in such a way that, ideally, the print registers in close proximity with the pattern on the embossing medium. However, the degree of registration is never 100% across the entire printed surface. Missed registration can result for a number of reasons. For example, during normal handling the printed décor can expand or contract in respond to varying ambient moisture levels, completely independent of the embossing medium. Moreover, the décor may not be brought into the press in good registration with the embossing medium. Finally, even if these problems are avoided, as the pressure in the press increases and the heat rises all of the materials (décor, phenolic, board and embossing medium) in the press expand at different rates. Since the greatest differential in dimensional change occurs at the diagonal corners, this is usually where the greatest variation in registration is observed.

### SUMMARY

The inventor has discovered methods of creating an “embossed in register” effect that includes a three-dimensional embossed pattern in registration with a printed décor surface across substantially the entire surface. In preferred implementations, registration is perfect (no mis-registration is observable with the naked eye) across the entire surface, even in the diagonal corners. This is achieved by using an embossed release medium to transfer ink directly from the raised areas of its embossed structure (“tip print” the ink) onto an unprinted décor during embossing.

In one aspect, the invention features a method of manufacturing a product carrying an embossed texture and a printed pattern in register with the embossed texture, the method comprising: (a) providing a substrate having a surface; (b) providing an embossing medium carrying an embossed pattern defining raised portions and recessed portions; (c) applying an ink to the raised portions of the embossed pattern; (d) transferring the ink from the embossing medium to the surface of the substrate, and (e) applying pressure to the embossing medium and substrate to impart the inverse of the embossed pattern to the surface of the substrate to form the product.

Some implementations include one or more of the following features. The product is a sheet-form product or laminate. The substrate is a sheet-form substrate (e.g., a sheet-form web or sheets of sheet-form material). Steps (d) and (e) may occur substantially simultaneously. The applying step may utilize a gravure, flexo, offset or be performed as an off-line process and steps (d) and (e) are performed subsequently on a separate production line. Step (c) may include winding the embossing medium carrying the ink into a roll. The process may further include sheeting the embossing medium carrying the ink prior to performing steps (d) and (e). Steps (d) and (e) may be performed in a laminating press. The process may further include drying or b-staging the ink after applying the ink to the embossing medium. The term “b-stage” or “b-staging,” as used herein, refers to the treatment of a flowable material such that it becomes solidified but not cured. Such treatments include but are not limited to thermal, free radical, and radiation-induced solidification. The substrate may be a laminate including multiple layers, e.g., a décor layer and a board or phenolic layer. Step (e) may be performed in a manner so as to laminate together the layers to form a finished laminate. In some implementations, the embossing medium may comprise either an embossed release sheet, embossed caul, or continuous embossed belt. The process may further include re-using the embossing medium by repeating step (c) after steps (d) and (e) have been performed once.

In another aspect, the invention features a product comprising a substrate having a surface carrying an embossed texture and a printed pattern in registration with the embossed texture, the embossed texture being in registration with the printed pattern across the entire extend of the surface. The substrate may comprise a laminate, and may be a sheet-form material. In some cases, the laminate includes a melamine layer. The laminate may comprise a board layer and a décor layer. The product may be a flooring product. Alternatively, the product may be any product having an embossed pattern and a printed pattern in register with the embossing, e.g., a laminate for use in furniture, countertops or the like, or a decorative sheet material for use as a wall covering.

The details of one or more embodiments of the invention are set forth in the accompanying drawings and the description below. Other features and advantages of the invention will be apparent from the description and drawings, and from the claims.

### DESCRIPTION OF DRAWINGS

FIGS. 1A-1E are a sequence of diagrammatic views showing steps in a tip printing and embossing process, with FIG. 1E showing the final embossed and printed product.

FIG. 2 is a diagrammatic view of a printing and embossing production line according to one implementation.

FIG. 3 is a diagrammatic view of a printing and embossing production line according to another implementation.

FIG. 4 is a flow chart illustrating alternative methods of using off-machine tip printed stock for continuous and high pressure (static) laminating.

### DETAILED DESCRIPTION

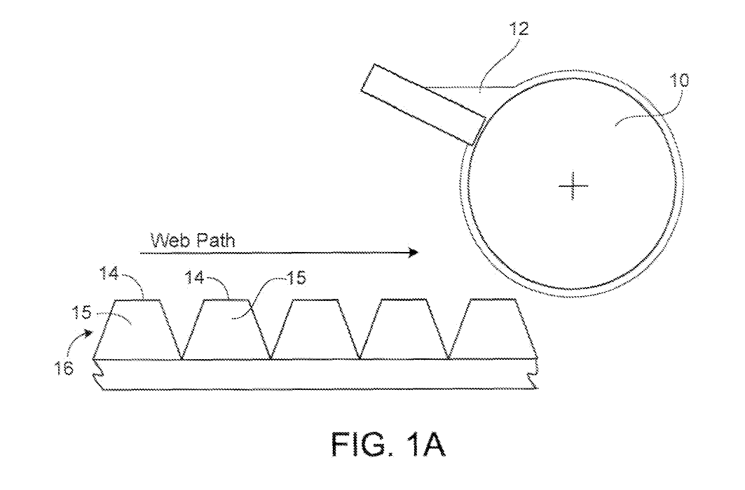

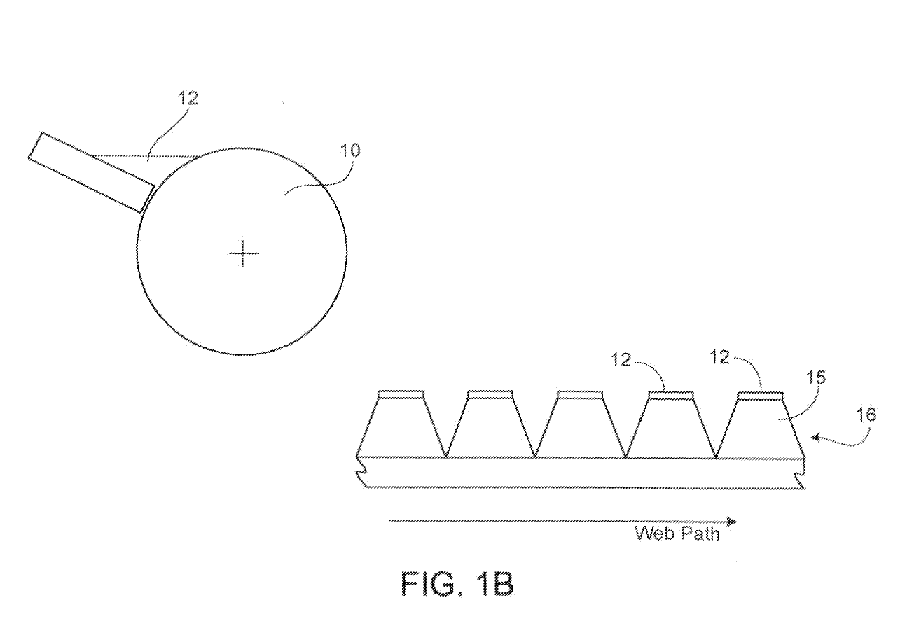

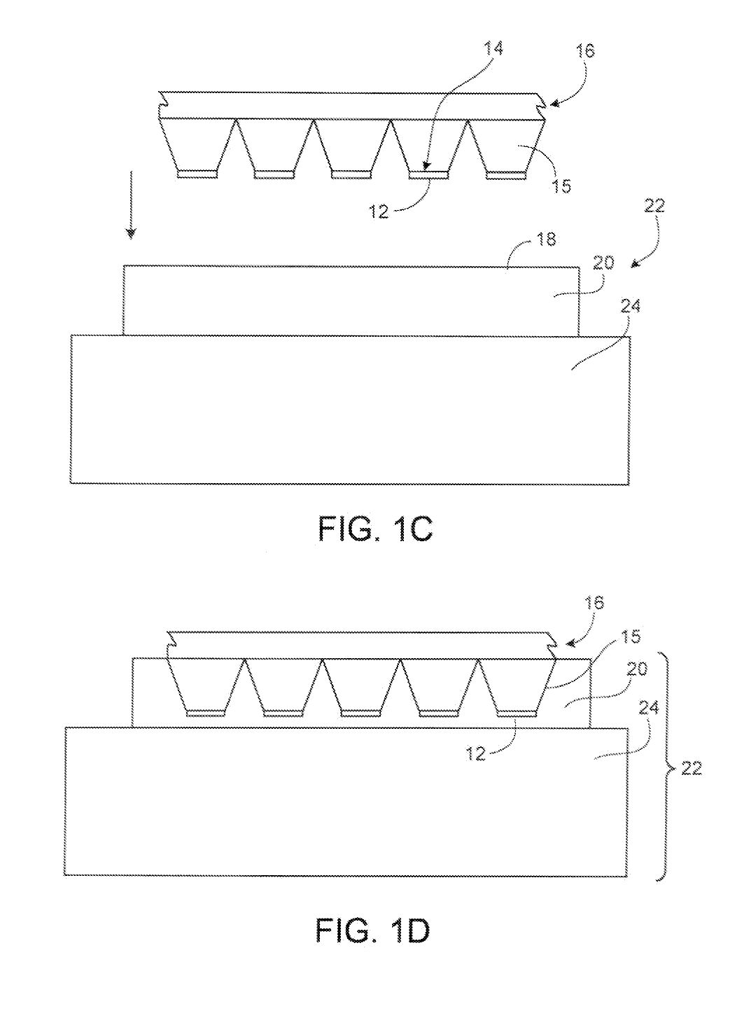

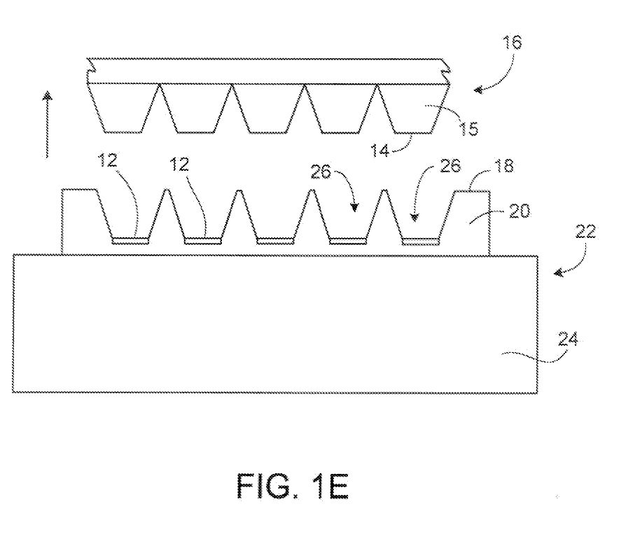

The basic steps in a process for tip printing an embossing medium and subsequently using the printed embossing medium to emboss a laminate are shown in FIGS. 1A-1E.

First, a printing roll 10 is used to apply a printing ink 12 to the raised surfaces 14 of the “hills” 15 of an embossed release medium 16 (FIGS. 1A-1B). Because a tip printing technique is used, only the raised surfaces are coated with ink, with the “valleys” or recessed areas of the embossed pattern remaining free of ink, as shown in FIG. 1B. Generally, tip printing is accomplished by moving the embossed release medium 16 past the printing roll 10 in the direction of the arrow in FIG. 1A. Tip printing may be performed using any suitable printing technique, e.g., gravure, flexo, offset, rotary, and other well known printing techniques.

A wide variety of embossed release mediums can be used. The embossed release medium may be in the form of a continuous web, or a sheet/panel/plate. For example, the embossed release medium may be an embossed release web of film or paper, an embossed caul, a continuous belt, an engraved metal roll or plate, or the like. The embossed pattern may be imparted to the embossed release medium in manners other than embossing or engraving, e.g., by imparting a surface texture to a film of curable resin on a paper or film substrate using an engraved roll and curing the resin against the roll.

The tip printed embossed or texture release medium is placed in a laminating press, either static or continous—either as a web or a sheet/panel/plate. Its functional side, with the embossed or texture surface and the tip printed ink, is placed in direct contact with the surface 18 to be embossed, e.g., the face or aesthetic/functional side of a décor layer 20 of a laminate 22 (FIGS. 1C-1D). Décor layer 20 may overlay any desired laminate layers, e.g., a board 24 as shown.

The material to be embossed is typically a laminate, for example a high or low pressure melamine/phenolic laminate, direct laminate or thermally fused melamine laminate. Such laminates are used in applications where a decorative surface texture with an in-register printed pattern is desired, e.g., for flooring, furniture, counter tops, wall covering, and other applications where a wood, stone or other texture is desired.

This package (laminate layers and tip printed ink on the release medium) is then pressed and/or cured by either heat, heat and pressure or some form of radiation (i.e., ultraviolet (UV) or electron beam) (FIG. 1D). This process causes the laminate to cure. Due to the applied pressure, the inverse of the embossing texture in the release medium will be imparted to the surface of the cured laminate, and remain after the release medium is removed (FIG. 1E). The embossed surface will also carry the tip printed ink 12, in register with the recessed areas 26 of the embossed pattern. The ink will adhere to the embossed surface by mechanical and/or chemical bonding. For example, in some cases the décor sheet is in b-staged form coming into the press, and as the resin of the décor sheet liquefies in the press it encapsulates, adheres to or bonds to the ink.

After the embossed release medium is removed from the laminate, the release medium can be tip printed again and the entire process repeat over and over until the release medium fails.

In some implementations, the embossed release medium is formed by a method that includes coating a curable liquid onto a substrate, imparting a pattern to the coating, e.g., by a mold roll, curing the coating, and stripping the substrate and cured coating from the pattern-impairing surface. Preferably, the entire process is conducted on a continuous web of material which is drawn through a series of processing stations. The use of this type of embossed release medium will result in very high fidelity, e.g., substantially 100% fidelity, replication of the desired pattern.

In one such process a web, e.g., a polymeric film, first passes through a coating station at which a coating head applies a wet coating to a surface of the web. Next, the coated web passes through a nip between a backing roll and an engraved roll, with the wet coating facing the engraved roll. The engraved roll carries a pattern on its surface, the inverse of which is imparted to the wet coating. Nip pressure is generally relatively low (e.g., “kiss” pressure), with the nip pressure being selected based on the viscosity of the coating to prevent the coating from being squeezed off of the web, while still allowing the engraved texture to be imparted to the coating. Typically, higher viscosity coatings and deeper patterns will require relatively higher nip pressures.

After leaving the nip, the coated and patterned web passes through a curing station, e.g., an electron beam or UV curing device. The coating is cured while it is still in contact with the surface of the engraved roll. Electron beam energy or acting radiation is generally applied from the back surface of the web and passes through the web and cures the coating to form a cured, textured coating that is firmly adhered to the web. At this point, the web and cured coating may be stripped off the engraved roll and wound up on a take-up roll or fed directly into the tip printing process.

The coating preferably includes an acrylated oligomer, a monofunctional monomer, and a multifunctional momomer for crosslinking. If ultraviolet radiation is used to cure the acrylic functional coating, the coating will also include a photoinitiator as is will known in the art. The coating may be applied using any suitable method. Suitable techniques include offset gravure, direct gravure, knife over roll, curtain coating, and other printing and coating techniques. The engraved roll is one example of a replicative surface that may be used to impart the pattern to the wet coating. Other types of pattern-imparting devices may be used. The coating may be cured by thermal curing, electron beam radiation, or UV radiation. Electron beam radiation is preferred in some cases because it can penetrate the thick coatings required for certain desired patterns. Electron beam radiation units are readily available an typically consist of a transformer capable of stepping up line voltage and an electron accelerator. Manufacturers of electron beam radiation units include for example, Energy Sciences, Inc. Suitable UV curing devices are commonly available, e.g., from Fusion, Inc., Gaithersburg, Md. Suitable materials for the coating are disclosed, for example, in U.S. Ser. No. 11/444,711, filed Jun. 1, 2006, the full disclosure of which is incorporated herein by reference.

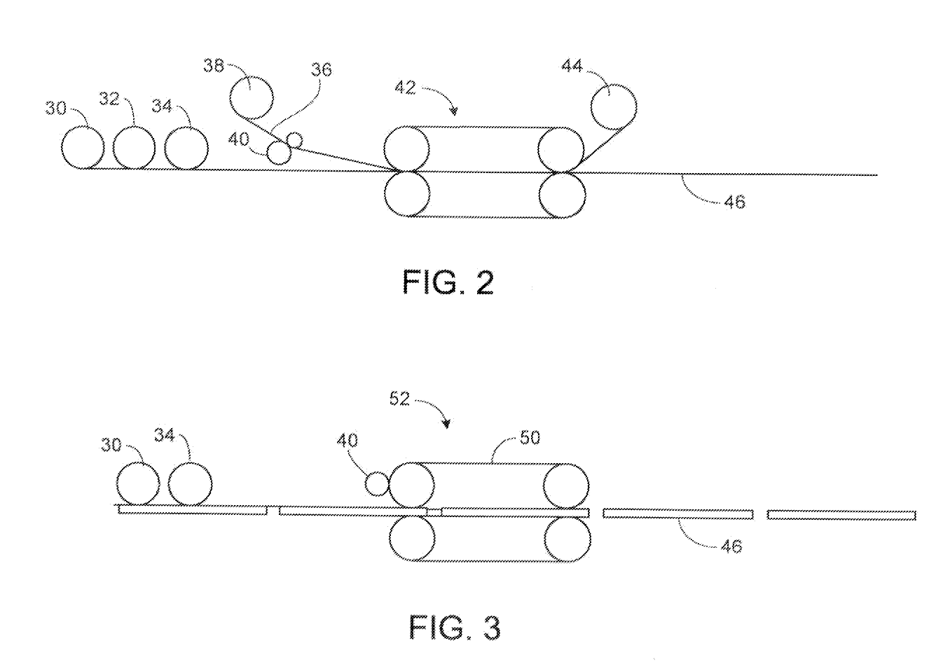

Examples of two alternative processes utilizing the embossing and printing steps described above are shown diagrammatically in FIGS. 2 and 3.

Referring first to FIG. 2, in one process the layers of the laminate (e.g., phenolic impregnated web, décor and overlay) are introduced to the production line from supply rolls 30, 32 and 34. The overlay is an optional layer, used to protect the décor layer in applications requiring a high degree of durability, such as flooring. The overlay may be, for example, an alpha-cellulose sheet that is impregnated with a clear melamine/aluminum oxide coating. An embossed release paper 36 is fed from a supply roll 38 past a print roll 40, where the embossed surface of the paper (not shown) is tip printed as described above. The tip printed paper is then fed into the nip of a continuous pressure laminate (CPL) press 42, along with the laminate layers, with the embossed and tip printed surface facing the uppermost surface of the laminate (e.g., the overlay layer, or décor layer if no overlay is present). The release paper and laminate layers pass through the press, during which the laminate is transfer printed, embossed and cured as described above. As the laminate and release paper exit the press, the release paper is stripped from the cured laminate and wound onto a take-up roll 44 for reuse or disposal. The finished laminate 46 exists the line and can be rolled up, sheeted and packaged for shipping. Generally, a board layer is glued to the finished laminate in a separate operation (not shown).

The process shown in FIG. 3 is similar, except that the embossing medium is a continuous embossed belt 50 rather than an embossed release paper fed from a supply roll, and the press is a direct laminate press (i.e., a press in which the board layer that is applied post-lamination in the process described above is instead laminated directly to a board 31. The embossed belt 50 cycles through a continuous direct laminate press 52, after being tip printed by print roll 40. In this case, print roll 40 is positioned just above the nip at the entrance to the press 52. The continuous belt used in this implementation can also be used in the implementation described above (i.e., in a CPL press) if desired.

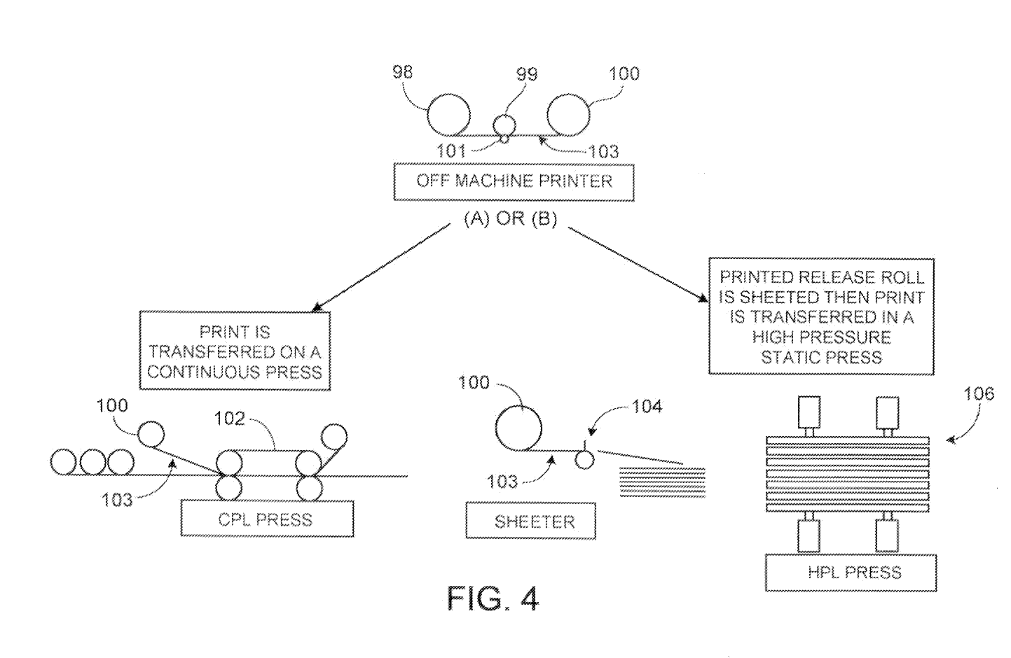

Referring now to FIG. 4, ink can be tip printed continuously on an embossed release web 98 by a print head 99 in an “off-machine” process and would into a roll 100. Ink is applied to surface 103 of the web by a print roll 101 of the print head 99. Generally, the ink is dried or b-staged prior to rolling, to avoid smudging or ink transfer. The tip printed release web is then either (A) used in roll form (roll 100) in a continuous of fast cycle, single opening press (CPL press) 102, or (B) sheeted by a sheeter 104 for use in a high pressure static press (HPL press) 106.

Any desired materials may be used in the process. The ink is generally selected both for its aesthetic properties and for its adhesion to the surface onto which is it transferred. Typically, the ink should be chemically compatible with the surface to which it is to be bonded. For laminates having a melamine surface layer, suitable inks include pigment based organic inks commercially available from companies such as Arcolor AG. Hartmann, and other suppliers of ink to the laminate industry. The rheology of the ink should be suitable for the tip printing process used. It is generally described that the ink be suitable for lamination at the desired laminating and resistant to bleeding in resins that cured, be resistant to removal from the finished laminate by heat, and/or solvents. It is also generally desirable that the pigments used in the ink have high color strength and color fastness, and exhibit good heat stability, e.g., up to the laminating temperature that is to be used, for example 240° C.

A number of embodiments of the invention have been descried. Nevertheless, it will be understood that various modifications may be made without departing from the spirit and scope of the invention. For example, the printing and embossing processes described above can be used in manufacturing laminates having other types of layers, or single layer materials. Accordingly, other embodiments are within the scope of the following claims.

What is claimed is:

1. A method of manufacturing a product carrying an embossed texture and a printed pattern in register with the embossed texture, the method comprising:
(a) providing a substrate having a surface;
(b) providing an embossing medium carrying an embossed pattern defining raised portions and recessed portions;
(c) applying an ink to the raised portions of the embossed pattern;
(d) transferring the ink from the embossing medium to the surface of the substrate, and
(e) applying pressure to the embossing medium and substrate to impart the inverse of the embossed pattern to the surface of the substrate to form the product.

2. The method of claim 1 wherein steps (d) and (c) occur substantially simultaneously.

3. The method of claim 1 wherein the substrate comprises a sheet-form material.

4. The method of claim 1 wherein step (d) comprises using a printing process selected from the group consisting of gravure, flexo, offset and rotary press processes.

5. The method of claim 1 wherein steps (c)-(e) occur on a single production line.

6. The method of claim 1 wherein step (c) is performed as an off-line process and steps (d) and (e) are performed subsequently on a separate production line.

7. The method of claim 6 wherein step (c) includes winding the embossing medium carrying the ink into a roll.

8. The method of claim 6 further comprising sheeting the embossing medium carrying the ink prior to performing steps (d) and (e).

9. The method of claim 1 wherein steps (d) and (e) are performed in a laminating process.

10. The method of claim 6 further comprising drying or b-staging the ink after applying the ink to the embossing medium.

11. The method of claim 1 wherein the substrate comprises layers of a laminate.

12. The method of claim 11 wherein step (e) is performed in a manner so as to laminate together the layers to form a finished laminate.

13. The method of claim 11 wherein the layers comprise a décor layer and a board layer.

14. The method of claim 1 wherein the embossing medium comprises an embossed release sheet.

15. The method of claim 1 wherein the embossing medium comprises an embossed caul.

16. The method of claim 1 wherein the embossing medium comprises an embossed continuous belt.

17. The method of claim 1 further comprising re-using the embossing medium by repeating step (c) after steps (d) and (e) have been performed.

18. The method of claim 14 further comprising forming the embossed release sheet by imparting a surface texture to a coating of curable resin on a paper or film using an engraved roll and curing the resin against the roll.

19. The method of claim 18 wherein the coating comprises an acrylated oligomer, a monofunctional monomer, and a multifunctional monomer for crosslinking.

20. A product comprising a substrate having a surface carrying an embossed texture and a printed pattern in registration with the embossed texture, the embossed texture being in registration with the printed acres the entire extent of the surface.

21. The product of claim 20 wherein the substrate comprises a laminate.

22. The product of claim 21 wherein the laminate comprises a board layer and a décor layer.

23. The product of claim 20 wherein the substrate comprises a sheet-form material.

24. The product of claim 20 wherein the product comprises a flooring product.

25. The product of claim 21 wherein the laminate comprises a melamine layer.
